(19) United States
(12) Patent Application Publication
(10) Pub. No.: US 2016/0274033 A1
(43) Pub. Date: Sep. 22, 2016

(54) IMAGING APPARATUS AND IMAGING METHOD

(71) Applicant: KABUSHIKI KAISHA TOSHIBA, Tokyo (JP)

(72) Inventor: Takeshi YAMANE, Tsukuba (JP)

(73) Assignee: KABUSHIKI KAISHA TOSHIBA

(21) Appl. No.: 14/817,253

(22) Filed: Aug. 4, 2015

(30) Foreign Application Priority Data
Mar. 16, 2015 (JP) 2015-051639

(51) Int. Cl. G01N 21/88; G01N 21/95

(52) U.S. Cl. CPC G01N 21/8806; G01N 21/9501; G01N 21/8851; G01N 2201/10; G01N 2201/0636; G01N 2021/8822

(57) ABSTRACT

According to one embodiment, an imaging apparatus includes a light source, a stage on which an object is placed and which is scanned in a predetermined direction, an illumination optical system supplying light from the light source to the object, an imaging optical system forming an image of the object, and a detector detecting the image of the object. The illumination optical system includes a plurality of mirrors located at a predetermined, position, and the plurality of mirrors have different inclinations and form an illumination region on a surface of the object, the illumination region being composed of a plurality of illumination portions in which no gap is formed when being viewed from the predetermined direction.

### CROSS-REFERENCE TO RELATED APPLICATIONS

This application is based upon and claims the benefit of priority from Japanese Patent Application No. 2015-051639, filed Mar. 16, 2015, the entire contents of which are incorporated herein by reference.

### FIELD

Embodiments described herein relate generally to an imaging apparatus and an imaging method.

### BACKGROUND

When mask substrates used for semiconductor devices are inspected for defects therein, the inspection needs to be performed fast with nigh detectability of defects. To perform the inspection fast with high detectability of defects, an imaging apparatus of high performance is essential.

However, achieving an imaging apparatus of high performance is not easy. It is especially difficult when an imaging apparatus to be achieved is to supply illumination of a sufficient amount of light to an object and perform imaging of the object within a short time.

### BRIEF DESCRIPTION OF THE DRAWINGS

FIG. 1 schematically shows the structure of an imaging apparatus of a first embodiment.

FIG. 2 snows an illumination region of the first embodiment.

FIG. 3 shows a detection region of a detector of the first embodiment.

FIG. 4 shows the structure of the detection region of the detector of the first embodiment.

FIG. 5 shows an example of modification in the illumination region of the first embodiment.

FIG. 6 shows another example of modification in the illumination region of the first embodiment.

FIG. 7 schematically shows the structure of an imaging apparatus of a second embodiment.

FIG. 8 shows an arrangement of a plurality of mirrors of the second embodiment, when being viewed from the direction of the optical axis of incident light.

FIG. 9 shows an arrangement of a plurality of mirrors of the second embodiment, when being viewed from the direction of the optical axis of reflected light.

FIG. 10 shows an illumination region of the second embodiment.

FIG. 11 shows a detection region of a detector of the second embodiment.

### DETAILED DESCRIPTION

In general, according to one embodiment, an imaging apparatus includes: a light source; a stage on which an object is placed and which is scanned in a predetermined direction; an illumination optical system supplying light from the light source to the object placed on the stage; an imaging optical system forming an image of the object illuminated by the illumination optical system; and a detector detecting the image of the object formed by the imaging optical system. The illumination optical system includes a plurality or mirrors located at a predetermined position, and the plurality of mirrors have different inclinations and form an illumination region on a surface of the object, the illumination region being composed of a plurality of illumination portions in which no gap is formed when being viewed from the predetermined direction.

Hereinafter, embodiments are described with reference to accompanying drawings.

### First Embodiment

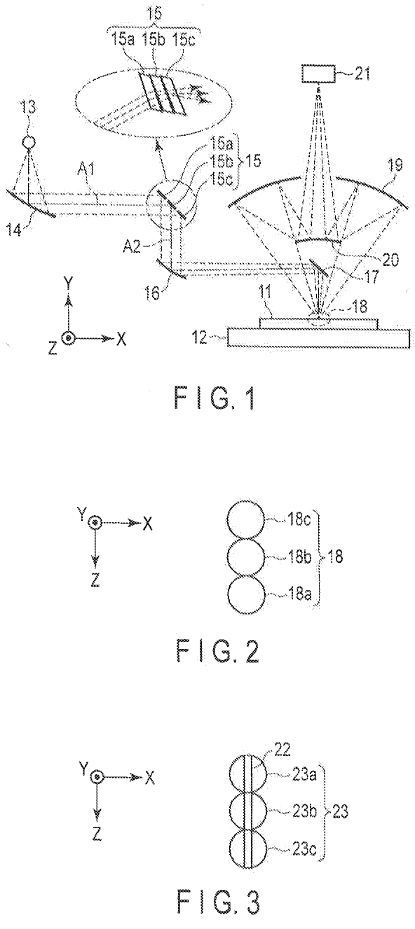

FIG. 1 schematically shows the structure of an imaging apparatus of a first embodiment. Note that, in FIG. 1, the horizontal axis is the x-axis, the vertical axis is the y-axis, and the axis of an imaginary line perpendicular to the figure surface is the z-axis for simpler explanation.

Hereinafter, the imaging apparatus and the imaging method of the present embodiment are explained with reference to FIG. 1, for example.

As an object 11, a lithography mask substrate used in a manufacture process of a semiconductor device is given. The mask substrate 11 includes a mask blank along with a mask having a circuit pattern. In the present embodiment, the mask blank is the mask substrate 11. The mask blank 11 is placed on a stage 12 to be scanned in the x-axial direction (predetermined direction).

Light from a light source 13 is supplied to the mask blank 11 placed on the stage 12 by an illumination optical system. The light source 13 is, for example, an extreme ultraviolet (EUV) light source. The illumination optical system is composed of an elliptical mirror 14, divided plane mirrors 15, elliptical mirror 16, and plane mirror 17. Note that the illumination optical system is a critical illumination optical system in which an image of the light source 13 is formed on the surface of the mask blank 11.

The divided plane mirrors 15 are a plurality of mirrors 15a, 15b, and I5c located at a predetermined position. The predetermined position corresponds to a pupil point of the illumination optical system or to the proximity of the pupil point. The pupil point is a position at which rays emitted from ail points of the light source 13 toward a certain direction are focused. The predetermined position should ideally correspond to the pupil point but may be set to the proximity to the pupil point if fire deviation does not affect the performance of the illumination optical system.

The plurality of mirrors 15a, 15b, and 15c have different inclinations. That is, the mirrors 15a, 15b, and 15c are inclined in different directions (inclined at different angles). Specifically, the mirrors 15a, 15b, and 15c are inclined at different angles with respect to the optical axis A1 of incident light as a rotation axis. More specifically, the mirror 15a and the mirror 15c are inclined in opposite directions of rotation with respect to the central mirror 15b.

With the mirrors 15a, 15b, and 15c disposed as above, the light reflected by the mirror 15a travels in a direction inclined toward the figure surface while the light reflected by the mirror 15c travels to the rearward of the figure surface. Consequently, the mirrors 15a, 15b, and 15c form an illumination region 18 on the mask blank (object) 11, which is composed of a plurality of illumination portions without a gap therein when being viewed from the x-axial direction which is the scanning direction (predetermined direction) of the stage 12.

FIG. 2 shows the illumination region 18. In FIG. 2, the horizontal axis, the vertical axis, and the axis of an imaginary line perpendicular to the figure surface correspond respectively to the x-axis, the z-axis, and the y-axis of FIG. 1. As shown in FIG. 2, the illumination region 18 composed of a plurality of illumination portions 18a, 18b, and 18c which have no gap therebetween in the x-axial direction is formed on the surface of the mask blank 11. The plurality of illumination portions 18a, 18b, and 18c are aligned linearly in the direction (z-axial direction) vertical with respect to the predetermined direction (x-axial direction). Note that the illumination portions 18a, 18b, and 18c are based on the mirrors 15a, 15b, and 15c, respectively.

The image on the mask blank 11 illuminated by the illumination optical system, that is, the image on the mask blank 11 illuminated by the illumination region 18 is formed by an imaging optical system composed of a concave mirror 19 and a convex mirror 20. The image on the mask blank 11 imaged by the imaging optical system is detected by a detector 21.

FIG. 3 shows a detection region 22 of the detector 21. In FIG. 3, the horizontal axis, the vertical axis, and the axis of an imaginary line perpendicular to the figure surface correspond to the x-axis, the z-axis, and the y-axis of FIG. 1, The detection region 22 forms an image region 23 which corresponds to the illumination region 18. That is, a plurality of image formation portions 23a, 23b, and 23c are formed to correspond to the illumination portions 18a, 18b, and 18c. As shown in FIG. 3, an inverted image of the illumination region 18 is projected to the image region 23, and thus, the image formation portions 23a, 23b, and 23c are upside down with respect to the illumination portions 18a, 18b, and 18c, and the longitudinal direction of the detection region 22 corresponds to the arrangement direction of the image formation portions 23a, 23b, and 23c. In other words, the longitudinal direction of the detection region 22 corresponds to the arrangement direction of the illumination portions 18a, 18b, and 18c.

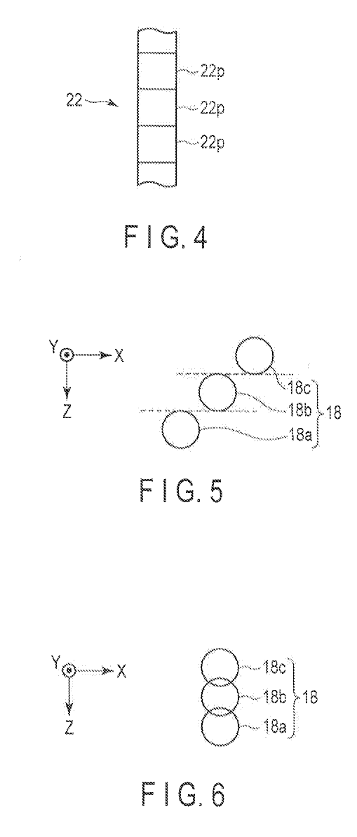

FIG. 4 shows the structure of the detection region 22 of the detector 21. As shown in FIG. 4, the detector 21 is a one-dimensional detector in which a plurality of pixels 22p are aligned in the longitudinal direction of the defection region 22.

The detector 21 acquires the image intensity of the image on the mask blank 11 scanning the stage 12 on which the mask blank 11 is placed in the x-axial direction. Specifically, positional coordinates on the surface of the mask blank 11 is defined to be associated with each pixel 22p of the detector 21, each image intensity detected in each pixel 22p is plotted as a function of the positional coordinates, and a dark-field image of the mask blank 11 is acquired. Then, the acquired dark-field image is analyzed to perform an inspection for defects in the mask blank 11.

As can be understood from the above, in the present embodiment, the mirrors 15a, 15b, and 15c are provided with the predetermined position (at the pupil point or at the proximity of the pupil point of the illumination optical system) such that they are inclined at different angles. Consequently, the illumination region 18 composed of the illumination portions 18a, 18b, and 18c in which no gap is formed when being viewed from the predetermined direction (the scanning direction of the stage 12) is formed on the surface of the object (mask blank 11). Therefore, the detector 21 which acquires the image of the object scanning the stage 12 can acquire an image of the object securely without a lack (a gap) in the image. Furthermore, since the longitudinal direction of the detection region 22 of the detector 21 corresponds to the arrangement direction of the illumination portions 18a, 18b, and 18c, the illumination is performed efficiently and the acquisition of the image of the object can be performed efficiently.

If an image of the object is detected without using the structure of the present embodiment, a circular illumination region having the same diameter as the length of the illumination region 18 shown in FIG. 2 is required, for example. If such a circular illumination region is used to detect an image of the object by the one-dimensional detector as shown in FIGS. 3 and 4, the illumination region has a relatively large portion which is unnecessary for the imaging process, that is, the illumination is performed with lower efficiency (lower illumination density).

Using the structure described above, the present embodiment can minimize the ratio of the unnecessary illumination region. Thus, the illumination is performed with higher efficiency (higher illumination density). The present embodiment can supply the illumination of a sufficient amount of light to the object and can perform the imaging process fast.

Note that, in the embodiment described above, the illumination portions 18a, 18b, and 18c are aligned linearly in the z-axial direction as shown in FIG. 2; however, no limitation is intended thereby. The illumination portions 18a, 18b, and 18c may be disposed to be apart from each other by adjusting the angles of the mirrors 15a, 15b, and 15c as shown in FIG. 5, Even if such an arrangement is adopted, as long as the illumination region 18 is composed of the illumination portions 18a, 18b, and 18c which have no gap when being viewed from the predetermined direction (x-axial direction), the advantage described above can be achieved as well.

Furthermore, adjacent illumination portions (18a and 18b, and 18b and 18c) may be arranged to overlap with each other as shown in FIG. 6.

Furthermore, in the embodiment described above, three mirrors 15a, 15b, and 15c are used to form three illumination portions 18a, 18b, and 18c; however, no limitation is intended thereby. The number of mirrors and the illumination portions can arbitrarily be changed.

Furthermore, in the embodiment, described above, the detector 21 is a one-dimensional detector, but is may be a two-dimensional detector in which the longitudinal direction of the detection region 22 corresponds to an arrangement direction of the illumination portions 18a, 18b, and 18c.

### Second Embodiment

Now, the second embodiment is explained. Note that the basic structure of the second embodiment is similar to that of the first embodiment and thus, the explanation considered redundant will be omitted.

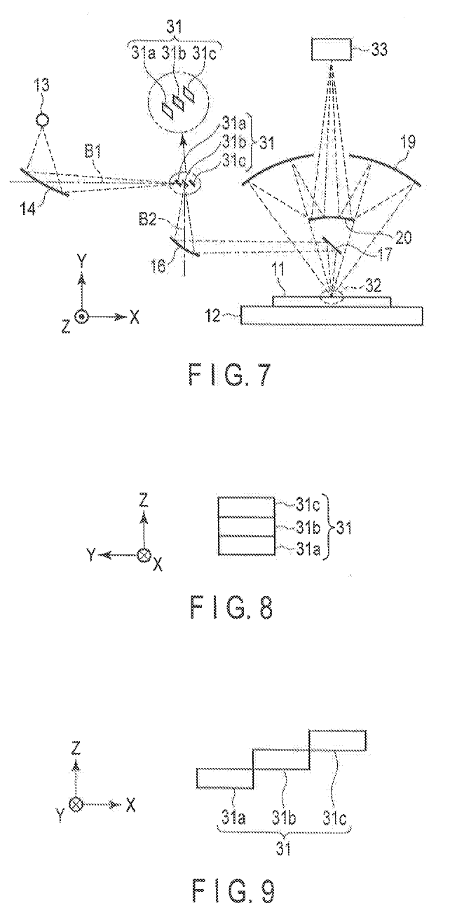

FIG. 7 schematically shows the structure of an imaging apparatus of the second embodiment. Note that, in FIG. 7, the horizontal axis is the x-axis, the vertical axis is the y-axis, and the axis of an imaginary line perpendicular to the figure surface is the z-axis, as in the first embodiment.

Hereinafter, the imaging apparatus and the imaging method of the present embodiment are explained with reference to FIG. 7, for example.

As in the first embodiment, a mask substrate of an object 11 is a mask blank. In the present embodiment, a stage 12 on which the mask blank 11 is placed is scanned in the z-axial direction (predetermined direction).

As shown in FIG. 7, divided plane mirrors 31 are a plurality of mirrors 31a, 31b, and 31c located at a predetermined position. The predetermined position corresponds to a conjugate point of a light source 13 or to the proximity of the conjugate point. The conjugate point is a position at which rays emitted from optional points of the light source 13 are focused. The predetermined position should ideally correspond to the conjugate point but may be set to the proximity to the conjugate point if the deviation does not affect the performance of the illumination optical system.

FIG. 8 shows positions of the mirrors 31a, 31b, and 31c when being viewed from the x-axial direction (direction of the optical axis B1 of incident light). FIG. 8 shows positions of the mirrors 31a, 31b, and 31c when being viewed from the y-axial direction (direction of the optical axis B2 of reflected light).

As can be understood from FIGS. 7, 8, and 9, the mirrors 31a, 31b, and 31c are shifted from each other in the direction of the optical ax is B1 of the incident light. Furthermore, the mirrors 31a, 31b, and 31c are parallel to each other and arranged in a stepwise manner when being viewed from the direction of the optical axis B2 of the reflected light (y-axial direction). Furthermore, the mirror 31a is disposed at the farther rear side than the mirror 31b with respect to the figure surface and the mirror 31c is disposed at the farther front side than the mirror 31b with respect to the figure surface.

With the mirrors 31a, 31b, and 31c arranged as above, an illumination region 32 composed of a plurality of illumination portions in which no gap is formed when being viewed from the z-axial direction of the scanning direction (predetermined direction) of the stage 12 is formed on the surface of the mask blank (object) 11.

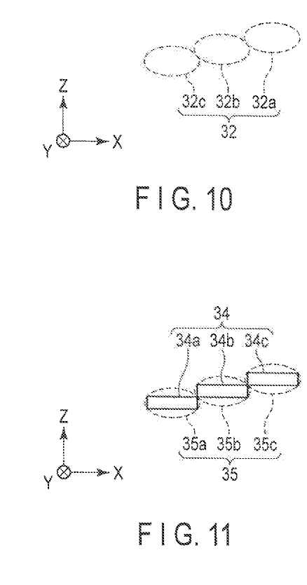

FIG, 10 shows the illumination region 32. In FIG. 10, the horizontal direction, vertical direction, direction of an imaginary line vertical to the figure surface correspond to the x-axial direction, the z-axial direction, and the y-axial direction of FIG. 7.

As shown in FIG. 10, the illumination region 32 composed of a plurality of illumination portions 32a, 32b, and 32c which have no gap therebetween when being viewed from the z-axial direction is formed on the surface of the mask blank 11. The plurality of illumination portions 32a, 32b, and 32c are based on the mirrors 31a, 31b, and 31c, respectively and are arranged to correspond to the arrangement of the mirrors 31a, 31b, and 31c when being viewed from the direction of the optical axis B2 of the reflected light. Therefore, the illumination portions 32a, 32b, and 32c are arranged in a stepwise manner. Furthermore, since an inverted image of the divided plane mirrors 31 is projected to the illumination region 32, the image is reversed vertically and horizontally.

The image on the mask blank 11 illuminated by the illumination region 32 is detected by a detector 33 in the same manner described in the first embodiment.

FIG. 11 shows a detection region 34 of the detector 33. In FIG. 11, the horizontal direction, vertical direction, direction of an imaginary line vertical to the figure surface correspond to the x-axial direction, the z-axial direction, and the y-axial direction of FIG. 7. The detection region 34 forms an image region 35 which corresponds to the illumination region 32. That is, the detection region 34 includes a plurality of detection portions 34a, 34b, and 31c, and a plurality of image formation portions 35a, 35b, and 35c are formed to correspond to the detection portions 34a, 34b, and 34c. Furthermore, the arrangement of the detection portions 34a, 34b, and 34c correspond to the arrangement of the illumination portions 32a, 32b, and 32c, Therefore, the detection portions 34a, 34b, and 34c are arranged in a stepwise manner. Furthermore, since an inverted image of the illumination region 32 is projected to the detection region 34, the image is reversed vertically and horizontally. Note that a one-dimensional detector in which a plurality of pixels are aligned in the longitudinal direction (x-axial direction) can be applied to each of the detection portions 34a, 34b, and 34c of the detector 33.

The detector 33 acquires the image intensity of the image on the mask blank 11 scanning the stage 12 on which the mask blank 11 is placed, in the z-axial direction. Then, as in the first embodiment, a dark-field image of the mask blank 11 is analyzed and an inspection for defects on the mask blank 11 can be performed.

As can be understood from the above, in the present embodiment, the mirrors 31a, 31b, and 31c are provided with the predetermined positions (at the conjugate point or at the proximity of the conjugate point of the light source) such that they are shifted from each other in the direction of the optical axis of the incident light. Consequently, the illumination region 32 composed of the illumination portions 32a, 32b, and 32c in which no gap is formed when being viewed from the predetermined direction (the scanning direction of the stage 12) is formed on the surface of the object (mask blank 11). Therefore, the detector 33 which acquires the image of the object scanning the stage 12 can acquire an image of the object securely without a lack (a gap) in the image. Furthermore, since the arrangement of the detection portions 34a, 34b, and 34c of the detection region 34 of the detector 33 correspond to the arrangement of the illumination portions 32a, 32b, and 32c of the illumination region 32, the illumination is performed efficiently and the acquisition of the image of the object can be performed efficiently.

Therefore, as in the first embodiment, the present embodiment can perform the illumination with higher efficiency (higher illumination density). Thus, the present embodiment can supply the illumination of a sufficient amount of light to the object and can perform the imaging process fast.

Note that, as in the first embodiment, the illumination portions 32a, 32b, and 32c may be disposed to be apart from each other as long as the illumination region 32 is composed of the illumination portions 32a, 32b, and 32c which have no gap when being viewed from the predetermined direction (z-axial direction) in the embodiment described above. Furthermore, adjacent illumination portions (32a and 32b, and 32b and 32c) may be arranged to overlap with each other, as in the first embodiment.

Furthermore, in the present embodiment, the number of mirrors and the illumination portions can arbitrarily be changed. Furthermore, in the present embodiment, a two-dimensional, detector may be used instead of a one-dimensional detector as in the first embodiment.

While certain embodiments have been described. these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fail within the scope and spirit of the inventions.

What is claimed is:

1. An imaging apparatus comprising:
a light source;
a stage on which an object is placed and which is scanned in a predetermined direction;
an illumination optical system supplying light from the light source to the object placed on the stage;
an imaging optical system forming an image of the object illuminated by the illumination optical system; and
a detector detecting the image of the object formed by the imaging optical system,
wherein the illumination optical system includes a plurality of mirrors located at a predetermined position, and
the plurality of mirrors have different inclinations and form an illumination region on a surface of the object, the illumination region being composed of a plurality of illumination portions in which no gap is formed when being viewed from the predetermined direction.

2. The apparatus of claim 1, wherein the predetermined position corresponds to a pupil point of the illumination optical system or a proximity of the pupil point.

3. The apparatus of claim 1, wherein the plurality of mirrors are inclined at different angles with respect to an optical axis of incident light as a rotation axis.

4. The apparatus of claim 1, wherein the plurality of illumination portions are aligned linearly in a direction vertical to the predetermined direction.

5. The apparatus of claim 1, wherein a longitudinal direction of a detection region of the detector corresponds to an arrangement direction of the illumination portions.

6. The apparatus of claim 5, wherein the detector is a one-dimensional detector in which a plurality of pixels are arranged in the longitudinal direction of the detection region.

7. The apparatus of claim 1, wherein the object is a mask substrate for lithography.

8. An imaging apparatus comprising:
a light source;
a stage on which an object is placed and which is scanned in a predetermined direction;
an illumination optical system supplying light from the light source to the object placed on the stage;
an imaging optical system forming an image of the object illuminated by the illumination optical system; and
a detector detecting the image of the object formed by the imaging optical system,
wherein the illumination optical system includes a plurality of mirrors located at a predetermined position, and
the plurality of mirrors are shifted from each other in a direction of an optical axis of incident light and form an illumination region on a surface of the object, the illumination region being composed of a plurality of illumination portions in which no gap is formed when being viewed from the predetermined direction.

9. The apparatus of claim 8, wherein the predetermined position corresponds to a conjugate point of the light source or a proximity of the conjugate point.

10. The apparatus of claim 8, wherein the plurality of mirrors are arranged in a stepwise manner when being viewed from a direction of an optical axis of reflected light.

11. The apparatus of claim 8, wherein the plurality of mirrors are parallel to each other.

12. The apparatus of claim 8, wherein an arrangement of the illumination portions corresponds to an arrangement of the mirrors viewed from a direction of an optical axis of reflected light.

13. The apparatus of claim 8, wherein a detection region of the detector includes a plurality of detection portions, and an arrangement of the detection portions corresponds to an arrangement of the illumination portions.

14. The apparatus of claim 13, wherein the plurality of detection portions are arranged in a stepwise manner.

15. The apparatus of claim 8, wherein the object is a mask substrate for lithography.

16. An imaging method comprising;
scanning a stage on which an object is placed in a predetermined direction/
supplying light from a light source to the object placed on the stage by an illumination optical system;
forming an image of the object illuminated by the illumination optical system by an imaging optical system; and
detecting the image of the object formed by the imaging optical system by a detector,
wherein the illumination optical system includes a plurality of mirrors located at a predetermined position, and
the plurality of mirrors have different inclinations and form an illumination region on a surface of the object, the illumination region being composed of a plurality of illumination portions in which no gap is formed when being viewed from the predetermined direction.

17. The method of claim 16, wherein the predetermined position corresponds to a pupil point of the illumination optical system or a proximity of the pupil point.

18. An imaging method comprising:
scanning a stage on which an object is placed in a predetermined direction;
supplying light from a light source to the object placed on the stage by an illumination optical system;
forming an image of the object illuminated by the illumination optical system by an imaging optical system; and
detecting the image of the object formed by the imaging optical system by a detector,
wherein the illumination optical system includes a plurality of mirrors located at a predetermined position, and
the plurality of mirrors are shifted from each other in a direction of an optical axis of incident light and form an illumination region on a surface of the object, the illumination region being composed of a plurality of illumination portions in which no gap is formed when being viewed from the predetermined direction.

19. The method of claim 18, wherein the predetermined position corresponds to a conjugate point of the light source or a proximity of the conjugate point.
